(19) United States
(12) Patent Application Publication
(10) Pub. No.: US 2007/0007091 A1
(43) Pub. Date: Jan. 11, 2007

(54) Gas spring

(75) Inventors: Henrik Brehler, Aurachtal (DE); Udo Wendland, Koblenz (DE)

Correspondence Address: COHEN, PONTANI, LIEBERMAN & PAVANE, 551 FIFTH AVENUE, SUITE 1210, NEW YORK, NY, 10176, US

(73) Assignee: Stabilus GmbH

(21) Appl. No.: 11/482,433

(22) Filed: Jul. 7, 2006

(30) Foreign Application Priority Data
Jul. 8, 2005 (DE) 10 2005 031 950.5

(51) Int. Cl. F16F 5/00

(52) U.S. Cl. 188/266.1; 267/118; 267/124

(57) ABSTRACT

A gas spring has a pressure cylinder consisting of nonmagnetic material and closed at two ends, and a piston movably guided in the pressure cylinder. The piston divides the pressure cylinder into a first working chamber and a second working chamber, which are both filled with a pressurized fluid and are connected by at least one flow connection. A piston rod is connected to the piston, extends through the second working chamber and projects out from the second working chamber. An adjusting device is provided to adjust an outward-travel distance of the piston rod to different values, the adjusting device including a magnetic field generating device for generating a magnetic field which is adjustable to various positions along the pressure cylinder, and a shut-off valve influenceable by the magnetic field and designed to block the flow connection between the first working chamber and the second working chamber.

### BACKGROUND OF THE INVENTION

The invention pertains to a gas spring with a pressure cylinder, sealed at both ends, in which a piston is guided with freedom to slide back and forth, the piston dividing the pressure cylinder into a first working chamber and a second working chamber and carrying a piston rod which extends through and projects out from the second working chamber, wherein the first working chamber and the second working chamber are filled with a pressurized fluid a flow connection between the first working chamber and the second working chamber; and an adjusting device for adjusting the outward-travel distance of the piston rod.

In gas springs of this type, it is known that the outward-travel distance of the piston rod can be adjusted to different values in that, by rotation of the piston rod relative to the piston, the piston rod, which engages with a thread in a corresponding threaded bore in the piston, can be screwed to a greater or lesser depth into the piston.

This approach, however, allows the outward travel to be varied over only a limited distance.

### SUMMARY OF THE INVENTION

It is an object of the present invention to create a gas spring in which the outward-travel distance of the piston rod can be easily adjusted, and the outward-travel distance extends over a significant fraction of the length of the cylinder.

According to a preferred embodiment of the present invention, the gas spring comprises a longitudinally extending pressure cylinder consisting of nonmagnetic material and closed at two ends; a piston slidably guided in the pressure cylinder, the piston dividing the pressure cylinder into a first working chamber and a second working chamber, which are both filled with a pressurized fluid and are connected by a flow connection; a piston rod connected to the piston, extending through the second working chamber and sealedly projecting out from the second working chamber; and an adjusting device for variably adjusting an outward-travel distance of the piston rod, the adjusting device comprising a magnetic field generating device designed to generate a magnetic field which is adjustable to various longitudinal positions along the pressure cylinder, and a shut-off valve influenceable by the magnetic field and designed to block the flow connection between the first working chamber and the second working chamber.

Because the position of the magnetic field along the length of the pressure cylinder is adjustable, the outward-travel distance of the piston rod can be varied between a small fraction of the possible outward-travel distance and the full amount of outward-travel distance.

Because the pressure cylinder consists of nonmagnetic material, it cannot shield the magnetic field and cannot impair the magnetic actuation of the shut-off valve.

The pressure cylinder can be given considerable strength by making it out of a nonmagnetic metallic material, especially aluminum or high-grade steel.

It is also possible, however, to make the pressure cylinder out of plastic.

The magnetic field can be located on the piston and act radially outward from the pressure cylinder. It is advantageous, however, for the magnetic field to be generated by a magnet mounted on the outside surface of the pressure cylinder.

Designing the magnet so that it surrounds the pressure cylinder in a ring-like manner ensures that the magnet will act radially in a uniform manner on the interior of the pressure cylinder all the way around its circumference.

The magnet may be assembled from a plurality of separately controllable electromagnets, permanently arranged next to each other along the length of the pressure cylinder.

It is also possible, however, that the position of the magnet along the length of the pressure cylinder is variable. So that the magnet can be positioned easily, it can be held in the desired position either by friction-locking or by form-locking.

The magnet can be either a permanent magnet or an electromagnet.

To simplify the adjustment, the magnet can be designed to slide back and forth on the pressure cylinder. The magnet is preferably mounted on a slide ring, which can slide axially back and forth on the pressure cylinder. The slide ring consists of nonmagnetic material, especially a plastic.

If the second working chamber contains a separating piston, which surrounds the piston rod, divides the second working chamber into a first working space and a second working space, contains magnetic material or consists of a magnetic material, and has a passage connecting the first and the second working spaces to each other, which passage can be closed by a closing element mounted on the piston or on the piston rod when the piston is a certain distance away from the separating piston, any change in the position of the magnet is automatically accompanied by a simultaneous, corresponding change in the position of the separating piston. Both the magnet and the separating piston are then always located in the same position, because the magnetic field connects the two of them together in a contact-free manner.

The separating piston then forms a stop, which limits the travel of the piston and of the piston rod.

In a reversal of the kinematics, the separating piston could contain the magnet, and a corresponding magnetic ring element can be mounted on the pressure cylinder with the freedom to shift position.

The separating piston or, in a reversal of the kinematics, the magnetic ring element, can consist of magnetic steel or contain magnetic steel.

It is also possible, however, that the separating piston consists of a permanent magnet with a polarity which is opposite the polarity of the magnet on the pressure cylinder.

In a simple embodiment, the passage can be a through-bore in the separating piston or a ring-shaped gap between the radially outward directed circumferential lateral surface of the piston rod and the wall of a through-bore in the separating piston through which the piston rod passes, and the closing element can be a sealing ring, which is either mounted permanently on the piston rod or is axially supported on the piston, and which can be set onto the through-bore or the ring-shaped gap or can be placed around it to seal it off.

According to another preferred embodiment, the separating piston can move axially with respect to the piston between a closed position, in which the passage is blocked, and an open position, the separating piston being spring-loaded in the direction toward the open position so that it moves concomitantly with the piston when the piston moves. When the separating piston arrives in the area of the magnetic field of the magnet mounted on the outside surface of the pressure cylinder, the separating piston is prevented from moving any farther. Any further movement of the piston and of the piston rod in the outward direction has the result that the stopped separating piston moves from the open position toward the closed position, in which it blocks the passage.

To define the travel distance, the distance over which the separating piston moves in the open position can be limited by a stop.

If the cross section of the passage is variable as a function of the position of the separating piston between the closed position and the open position, the course of the piston's travel can be influenced.

For this purpose, one or more longitudinal grooves can be formed in the piston rod or in a projection from the piston, i.e., in the area which can be surrounded by the separating piston.

In principle, a damping device can be present, which damps the final stage of the predetermined outward movement of the piston and of the piston rod.

A simple design of a damping device of this type with progressive damping consists in that the cross section of the longitudinal grooves decreases toward the closed position.

When the piston is not located in the area of the magnetic field, the separating piston is in an area of the longitudinal grooves in which these grooves allow the fluid to flow through with essentially no throttling. Only when the magnetic field moves the piston in the closing direction the cross section of the passage decreases and throttling begins.

The piston rod or the projection from the piston can also be designed without grooves in the area of the closed position.

So that the end of the outward travel can be damped in this case, it is possible for the cross section of the piston rod or of the projection from the piston in the area of the piston rod or projection which can be surrounded by the separating piston, to increase as it proceeds toward the closed position.

A simple way to block the flow connection between the first and the second working chamber is to have the piston rod or the projection from the piston tightly surrounded by the separating piston when in the closed position.

A passage which connects the first working chamber to the first working space can be provided in the piston.

So that, when the actuating force acting in the outward-travel direction increases, the first and second working chambers can be connected to each other and the piston can move farther in the outward direction, an additional connection leading from the second working chamber to the first working chamber can be provided in the piston. This second connection can be blocked by a valve, especially by a pretensioned nonreturn valve, which blocks the flow from the second working chamber to the first working chamber.

The magnet mounted on the outside surface of the pressure cylinder is held in place by the magnetic field, which means that it is arrested in a contactless manner. If this arrest can be overcome, the magnet can be carried along with the separating piston into a new position, in which it determines a new maximum outward-travel distance.

Another advantageous embodiment, which can function without a separating piston, consists in that the flow connection is formed in the piston and is provided with a valve, the closing lenient of which is spring-loaded in the opening direction and which can be actuated by the magnetic field in opposition to the force of the spring and thus moved into its closed position.

According to one possibility, the valve is a slide valve with a slide, consisting of magnetic material, which can move along its guide transversely with respect to the longitudinal dimension of the gas spring.

The valve slide can have a closing element on its lateral surface, this element being spring-loaded in the radially outward direction. When in the closed position, this closing element can block off the opening in the slide guide of the flow connection leading from the second working chamber to the first working chamber, so that, when forces being exerted increase, it is possible for the maximum outward-travel position determined by the magnetic field to be exceeded.

In a further embodiment, the valve is a seat valve, the valve element of which can be actuated in the longitudinal direction of the gas spring and thus moved into its closed position by the link of a link slide, which can move by the force of the magnetic field transversely to the longitudinal dimension of the gas spring in opposition to the spring-loading and thus move the valve element from its open position into its closed position. When the maximum outward-travel position determined by the magnetic field has been exceeded under the action of stronger forces, the link slide can be actuated in the longitudinal direction of the gas spring by the force of a spring acting in the closing direction of the valve element.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings, wherein like references are used to denote similar elements throughout the several vows:

FIG. 1 is a cross sectional view of a first exemplary embodiment of a gas spring;

FIG. 2 is a cross sectional view of a part of a second exemplary embodiment of a gas spring in the area of the piston;

FIG. 3 is a cross sectional view of a third exemplary embodiment of a gas spring;

FIG. 4 is a cross sectional view of a part of a fourth exemplary embodiment of a gas spring in the area of the piston; and

FIG. 5 is a cross sectional view of a part of a fifth exemplary embodiment of a gas spring in the area of the piston.

### DETAILED DESCRIPTION OF THE PREFERRED EMBODIMENTS

The gas spring illustrated here has a pressure cylinder 1 which is made from a nonmagnetic material, for example aluminum, high-grade steel or plastic, and which is closed off at both ends. The pressure cylinder 1 is divided by a piston 2 into a first working chamber 3 and a second working chamber 4, which are filled with a compressed gas.

A piston rod 5 is attached to one end of the piston 2. The piston rod 5 projects coaxially through the second pressure chamber 4 and is guided through the second working chamber 4 to the outside in a sealed manner by a guide and seal assembly 6.

A connector piece 7 is mounted both on the closed end of the first working chamber 3 and on the outward-projecting, free end of the piston rod 5.

The gas spring can serve preferably as a means for opening a hatch such as the rear hatch of a motor vehicle. For this purpose, one of the connector pieces 7 would be mounted on the rear hatch a certain distance away from a pivot axis of the hatch, and the other connector piece 7 would be mounted on a fixed body part of the motor vehicle, a certain distance away from the pivot axis of the hatch.

When the hatch is closed, the piston rod 5 is in its inward-travel position inside the pressure cylinder 1 and is held in this position by the closed lock of the hatch.

When the lock is opened, the gas pressure in the pressure cylinder 1 can push the piston 2 in the outward-travel direction 8, because the effective surface area of the piston 2 on the side facing the first working chamber 3 is larger than that on the side facing the second working chamber 4.

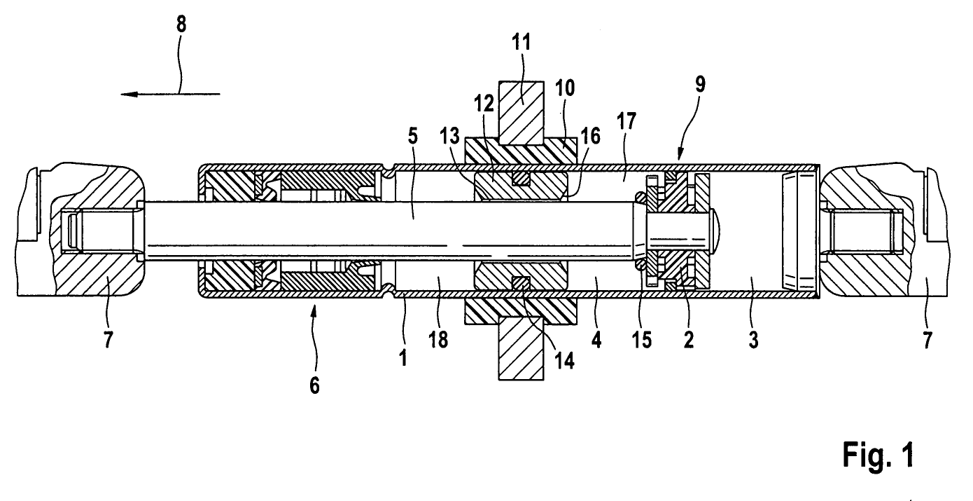

On the radially outward directed circumferential lateral surface of the piston 2, a flow connection 9 is formed, through which the gas can flow from the one working chamber 3 or 4 to the other working chamber 4 or 3. The cross section of the flow connection 9 in one flow direction is different from that in the other. The flow connection shown in FIG. 1 is described in U.S. Pat. No. 5,964,454, the entire content of which is incorporated herein by reference.

A slide ring 10 of plastic is mounted with freedom to slide back and forth on the pressure cylinder 1 of the gas spring shown in FIG. 1. The slide ring 10 is held frictionally in the selected position. A ring-shaped permanent magnet 11 is inserted into a radially outer circumferential groove in the lateral surface of the slide ring 10.

A steel separating piston 12 is mounted in the second working chamber 4 with freedom to slide back and forth. This piston surrounds the piston rod 5, forming a ring-shaped gap 13 between the radially outward directed circumferential lateral surface of the piston rod 5 and the inner wall of the through-bore in the separating piston 12. The separating piston 12 divides the second working chamber 4 into a first working space 17 and a second working space 18.

The separating piston 12 is sealed off against the inside wall of the pressure cylinder 1 by a sealing ring 14, mounted in the radially circumferential lateral surface of the separating piston 12.

As a result of the magnetic field generated by the permanent magnet 11, there is a coupling between the permanent magnet 11 and the separating piston 12, so that, when the permanent magnet 11 mounted on the slide ring 10 shifts position in the axial direction, the separating position 12 also shifts its position.

A second sealing ring 15, which surrounds the piston rod 5, is mounted in a conical recess in the piston rod 5, adjacent to the piston 2. This second sealing ring 15 is supported axially against the piston 2.

When the piston rod 5 travels outward in the direction of arrow 8, the piston 2 arrives in contact with the separating piston 12 by way of the sealing ring 15. The sealing ring 15 now rests against a conical opening 16 of the annular gap 13, thus sealing off the annular gap 13. The connection between the first working space 17 and the second working space 18 is now closed, and the separating piston 12 which is no longer able to slide is blocked.

The separating piston 12 thus forms a stop, which limits the outward travel of the piston rod 5. The position of the stop can be adjusted by shifting the axial position of the permanent magnet 11 on the pressure cylinder 1.

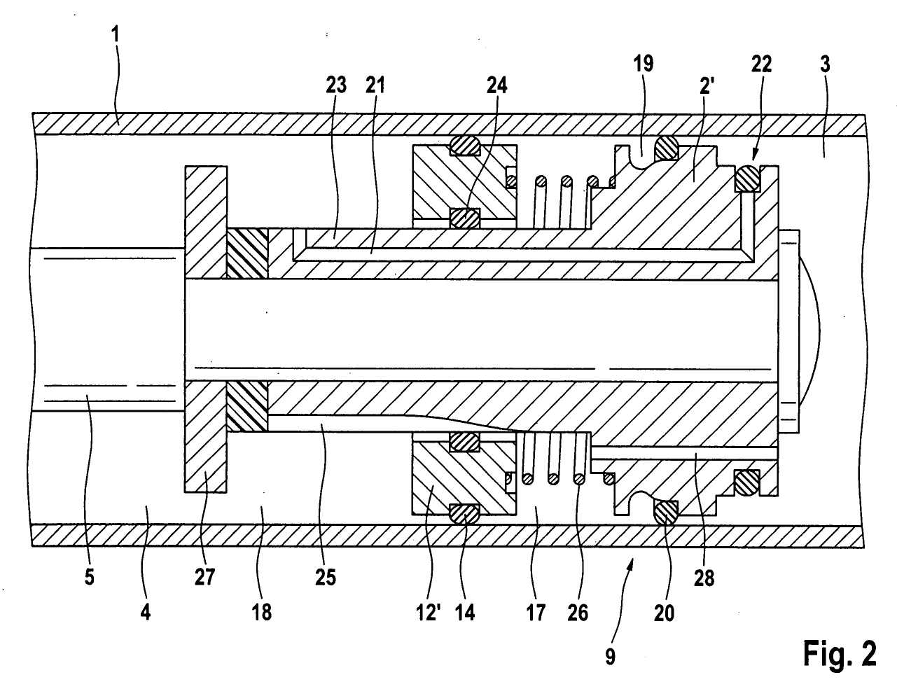

In the case of the piston 2′ of nonmagnetic material shown in FIG. 2, a third sealing ring 20 is mounted in a circumferential groove 19 formed in the radially outward lateral surface of the piston 2′. This sealing ring 20 rests against the inside wall of the pressure cylinder 1. The groove 19 is approximately twice as long in the axial direction as the diameter of the sealing ring 20 and has greater depth in the area facing the piston rod 5 than it does in the area facing away from the piston rod 5.

As a result, during the outward travel of the piston rod 5, the sealing ring 20 is located in the area of the groove 19 facing away from the piston rod 5 and rests against both the bottom of the groove 19 and also against the inside wall of the pressure cylinder 1. Thus the piston 2′ is sealed off against the inside wall of the pressure cylinder 1.

When the piston rod 5 travels inward, however, the sealing ring 20 can fit into the area of greater depth of the groove 19, thus allowing compressed gas to flow over it. This gas can now flow from the first working chamber 3 into the second working chamber 4.

The groove 19 with the sealing ring 20 forms a flow connection 9.

During the outward travel of the piston rod 5, the compressed gas can flow via a connection 21 leading from the second working chamber 4 to the first working chamber 3. Flow in the opposite direction through this connection can be blocked by a pretensioned nonreturn valve 22.

The piston 2′ has, on the piston rod side, a cylindrical projection 23 of smaller diameter, which is surrounded by a ring-like separating piston 12′ of steel, which can slide along the projection. In its radially outward directed circumferential lateral surface, the separating piston 12′ has an annular groove, into which a sealing ring 14 is installed, so that it rests against the inside wall of the pressure cylinder 1.

Another annular groove is formed in the wall of the through-bore in the separating piston 12′. This groove receives a sealing ring 24, which rests against the lateral surface of the projection 23.

A longitudinal groove 25 with a cross section which decreases as it proceeds toward the piston, is formed in the lateral surface of the projection 23.

The projection 23 has no groove in the area adjacent to the piston 2′.

A helical compression spring 26 surrounds the projection 23, leaving a certain gap to the cylinder wall. One end of this spring 26 is supported against the piston 2′, whereas the other end acts on the separating piston 12′. The separating piston 12′ is able to slide until it contacts a stop 27 a certain distance away from the piston 2′.

A slide ring 10 with a permanent magnet 11 encloses the pressure cylinder 1 in the same way as described for the exemplary embodiment of FIG. 1.

When, during the outward travel of the piston rod 5, the separating piston 12′, which normally rests against the stop 27, arrives in the area of the permanent magnet 11, a magnetic coupling is produced between the permanent magnet 11 and the separating piston 12′, and the separating piston 12′ is thus held in the position of the permanent magnet 11.

As the piston rod 5 continues to travel outward, the projection 23 moves relative to the now stationary separating piston 12′ until the separating piston 12′ comes to a stop near the piston 2′.

Because of the travel of the separating piston over the longitudinal groove 25, the cross section of the groove 25 and thus the gas flow through it is reduced, which has the effect of damping the outward travel movement. Movement continues until, in the end position, the groove 25 is completely closed and the outward-travel movement is stopped in the position determined by the permanent magnet 11. This position is variable and can be adjusted by shifting the position of the permanent magnet 11.

If the outward movement is to be continued beyond this position, external tensile force can be exerted on the piston rod 5 to move the separating piston 12′ out of the area of the permanent magnet 11 while opening the nonreturn valve 22. The separating piston 12′ will thus move back to the stop 27, and the passage through the longitudinal groove 23 is open again.

So that the separating piston 12′ can move all the way to its end position at the piston 2′, the piston has a channel 28, which connects the first working space 17 to the first working chamber 3.

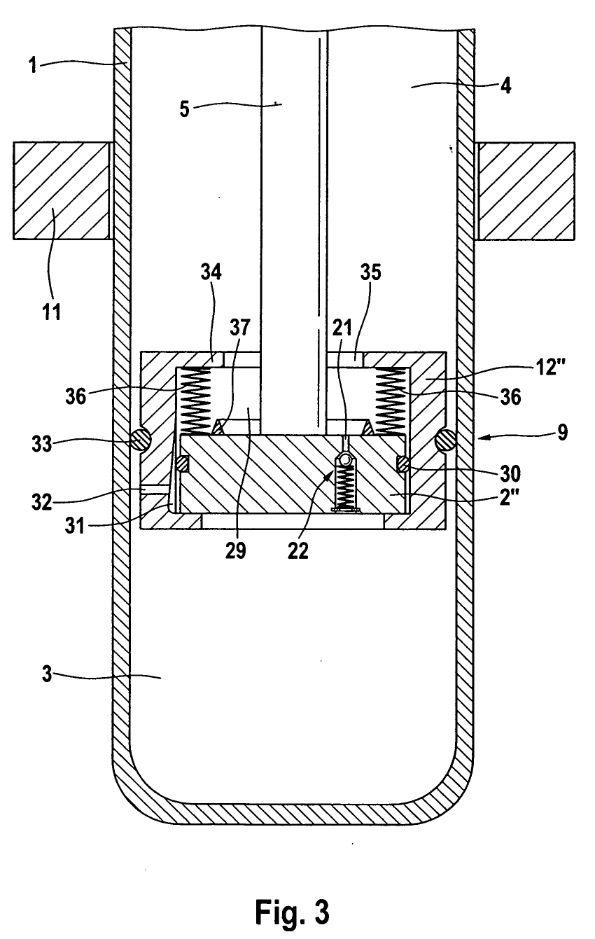

In the exemplary embodiment of FIG. 3, the pressure cylinder 1 again consists of a nonmagnetic material, in particular aluminum. In the same way as explained on the basis of the exemplary embodiments of FIGS. 1 and 2, a permanent magnet 11 is mounted on the pressure cylinder 1 with freedom to slide back and forth.

The piston 2″ carrying the piston rod 5 is guided with freedom to slide between two end positions in an axially open, cylindrical chamber 29 of a steel separating piston 12″. A sealing ring 30 mounted in an annular groove in the cylindrical lateral surface of the piston 2″ rests against the cylindrical surface of the chamber 29.

An inner wall of the separating piston 12″ forming the chamber 29 has a longitudinal groove 31 extending over a certain area in the side opposite to the piston rod 5. The cross section of this groove 31 increases toward the end of the piston 12″ facing away from the piston rod 5. This end of the longitudinal groove 31 is connected to the first working chamber 3 by a radial bore 32 in the separating piston 12″.

The separating piston 12″ has on its lateral surface a radially outward directed circumferential annular groove, into which a sealing ring 33 is inserted. The sealing ring 33 rests against the inside wall of the pressure cylinder 1 and forms a flow connection 9 corresponding to the flow connection shown in FIGS. 1 and 2.

On the piston rod side, the chamber 29 is separated by a ring-shaped wall 34 from the second working chamber 4. This wall 34 has a central opening 35, through which the piston rod 5 passes with play.

Compression springs 36 supported against the ring-shaped wall 34 push the separating piston 12″ axially away from the piston 2″.

During relative movement between the piston 2″ and the ring wall 34, a ring seal 37, mounted coaxially with respect to the piston 2″ on the end surface of the piston facing the ring-shaped wall 34, can come to rest against the ring-shaped wall 34 and thus block off the connection between the second working chamber 4 and the first working chamber 3 via the longitudinal groove 31 and the radial bore 32.

This blocking action occurs when, during the outward travel of the piston rod, the separating piston 12″ arrives in the area of the permanent magnet 11 and is held in place by the magnetic coupling produced by the magnetic field of the permanent magnet 11.

Slight additional outward travel of the piston rod 5 then leads to relative movement between the piston 2″ and the separating piston 12″ and to the contact of the ring seal 37 with the ring wall 34. This limits the outward travel of the piston rod 5.

The spring-loaded nonreturn valve 22 in the piston 2″, installed in a connection 21 in the piston 2″, can be opened by the exertion of additional force on the piston rod 5 in the outward travel direction, and thus the piston 2″ can travel beyond the stop position determined by the permanent magnet 11.

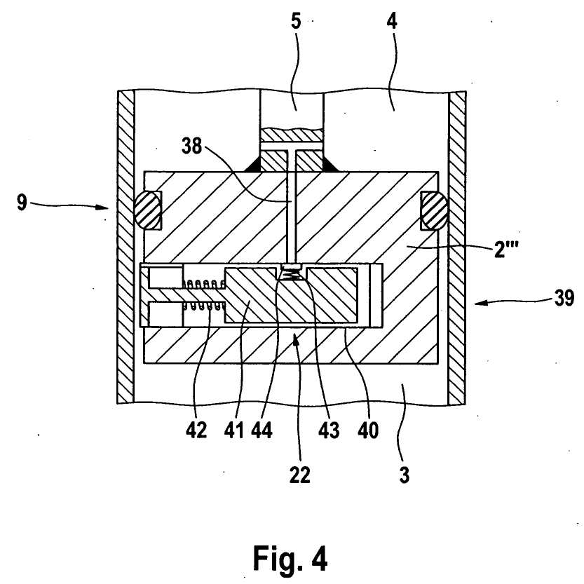

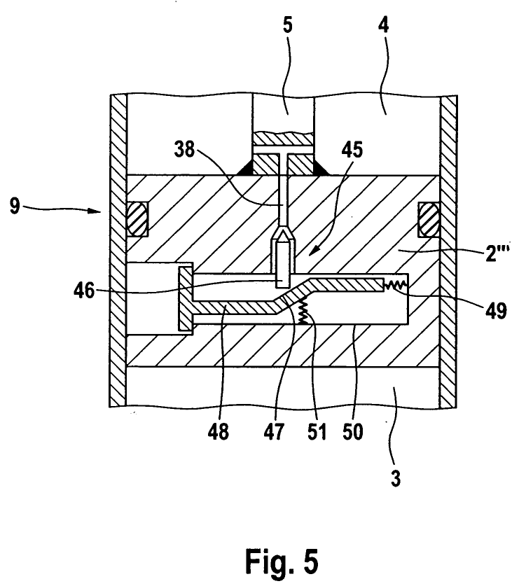

In the case of the exemplary embodiments shown in FIGS. 4 and 5, a connection 38 between the first working chamber 3 and the second working chamber 4 is provided in the piston 2′″, which is made of nonmagnetic material. This connection can be closed by a valve when the piston 2′″ reaches the area of a permanent magnet 11 in the same way as described for the preceding exemplary embodiments.

In FIG. 4, the valve is a slide valve 39 with a slide 41, made of steel, which can slide in a slide guide 40 transversely with respect to the longitudinal dimension of the gas spring. One end of the slide 41 projects out from the open end of the slide guide 40. A compression spring 42 acts on the valve slide 41, pushing it towards a stop on the end of the slide guide 40 opposite the open end.

When the piston 2′″ arrives in the area of the permanent magnet 11, the magnetic field of the magnet 11 pushes the valve slide 41 in opposite direction against the force of the compression spring 42.

The connection 38 leads from the second working chamber 4 to the slide guide 40. When the piston 2′″ is not in the area of the permanent magnet 11, the gas can flow along the valve slide 41 via the opening of the guide 40 into the first working chamber 3.

When the piston 2′″ arrives in the area of the permanent magnet 11, so that the valve slide 41 is pushed in opposite direction against the force of the compression spring 42, a nonreturn valve 22 mounted on the valve slide 41 becomes aligned with the opening of the connection 38 leading to the slide guide 40.

The nonreturn valve 22 has a closing element 44, which can be actuated longitudinally by a compression spring 43. When aligned with the opening of the connection 38, this closing element 44 seals off the opening and thus arrests the piston 2′″ in this position.

When the pressure in the second working chamber 4 is increased by the exertion of external force on the piston rod 5 in the outward-travel direction, the closing element 44 is lifted from the opening of the connection 38, in opposite direction against the force of the compression spring 43, and additional outward travel of the piston rod is made possible by this ability of gas to flow again from the second working chamber 4 into the first working chamber 3.

The flow connection 9 in the piston 2′″ (and piston 2″″ in FIG. 5) corresponds to the flow connection 9 shown in FIG. 1 and is not shown in detail in either FIG. 4 or FIG. 5.

In FIG. 5, the valve is a seat valve 45, the steel valve element 46 of which can be actuated in the longitudinal direction of the gas spring into its closed position by the ramp-like link 47 of a link slide 48.

When the piston 2″″ arrives in the vicinity of the permanent magnet 11, the link slide 48 is able to shift position transversely to the longitudinal direction of the gas spring in opposition to the force of a tension spring 49 from its open position into a closed position under the effect of the magnetic field. The ramp-like link 47 thus pushes the valve element 46 into the opening of a connection 38 formed in the piston 2″″ and leading from the second working chamber 4 to the guide 50 of the link slide 48, and thus closes this opening.

Because the guide 50 is connected to the second working chamber 4, a connection from the second working chamber 4 to the first working chamber 3 is interrupted, and the piston 2″″ is also locked in position.

The link slide 48 is also subject to the action of a compression spring 51, which pushes it against the valve element 46. The slide 48 can be deflected in the opening direction of the valve element 46 in opposition to the force of the compression spring 51.

If, after the valve element 46 has reached the permanent magnet 11 and closed off the connection 38, additional external force acting in the outward direction is exerted on piston rod 5, the pressure in the second working chamber 4 can be increased to such an extent that the valve element 46 is lifted away from the opening of the connection 38 in opposition to the force of the compression spring 51 and, as the piston rod 5 continues to travel outward, gas can flow from the second working chamber 4 into the first working chamber 3.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

We I claim:

1. A gas spring comprising:
a longitudinally extending pressure cylinder consisting of nonmagnetic material and closed at two ends;
a piston slidably guided in the pressure cylinder, the piston dividing the pressure cylinder into a first working chamber and a second working chamber, which are both filled with a pressurized fluid and are connected by a flow connection;
a piston rod connected to the piston, extending through the second working chamber and sealedly projecting out of one of the ends of the pressure cylinder from the second working chamber; and
an adjusting device for variably adjusting an outward-travel distance of the piston rod, the adjusting device comprising a magnetic field generating device designed to generate a magnetic field which is adjustable to various longitudinal positions along the pressure cylinder, and a shut-off valve influenceable by the magnetic field and designed to block the flow connection between the first working chamber and the second working chamber.

2. The gas spring of claim 1, wherein the pressure cylinder consists of nonmagnetic metallic material.

3. The gas spring of claim 1, wherein the pressure cylinder consists of plastic.

4. The gas spring of claim 1, wherein the magnetic field generating device is a magnet mounted on an outside surface of the pressure cylinder.

5. The gas spring of claim 4, wherein the magnet surrounds the pressure cylinder in a ring-like manner.

6. The gas spring of claim 4, wherein the magnet consists of a plurality of permanently mounted, separately controllable electromagnets, arranged next to each other along a length of the pressure cylinder.

7. The gas spring of claim 4, wherein the magnet is adjustable between various points along a length of the pressure cylinder.

8. The gas spring of claim 7, wherein the magnet is held in its selected position either by friction-locking or by form-locking.

9. The gas spring of claim 7, wherein the magnet is a permanent magnet or an electromagnet.

10. The gas spring of claim 7, wherein the magnet is displaceably mounted on the pressure cylinder with the freedom to slide longitudinally.

11. The gas spring of claim 10, wherein the magnet is mounted on a slide ring, which is slidable axially along the pressure cylinder, the slide ring consisting of a nonmagnetic material.

12. The gas spring of claim 4, further comprising a separating piston located in the second working chamber and comprising a magnetic material, the separating piston surrounding the piston rod and dividing the second working chamber into a first working space and a second working space, the separating piston having a first passage which connects the first said gas spring further comprising the second working spaces to each other, and said gas spring comprising a closing element located on the piston or the piston rod for closing the first passage when the piston is moved to a location a predetermined distance from the separating piston.

13. The gas spring of claim 12, wherein the separating piston comprises magnetic steel.

14. The gas spring of claim 12, wherein the separating piston comprises a permanent magnet with a polarity which is opposite to the polarity of the magnet on the pressure cylinder.

15. The gas spring of claim 12, wherein the first passage is an axial through-bore in the separating piston or an annular gap between a radially outward directed circumferential surface of the piston rod and a wall of a through-bore in the separating piston through which the piston rod passes; and wherein the closing element is a sealing ring mounted on the piston rod or axially supported against the piston which is set onto the axial through-bore or the annular gap to close it when the piston is moved to the location a predetermined distance from the separating piston.

16. The gas spring according to claim 12, wherein the separating piston is movable axially relative to the piston between a closed position, in which it closes the passage, and an open position, and is spring-loaded in the direction toward the open position.

17. The gas spring of claim 16, further comprising a stop limiting the travel of the separating piston toward the open position.

18. The gas spring of claim 16, wherein the cross section of the first passage changes as a function of the position of the separating piston between the closed position and the open position.

19. The gas spring of claim 18, wherein at least one longitudinal groove is formed in the area of the piston rod or of a cylindrical projection of the piston, the area being surrounded by the separating piston in at the least one position of the separating portion between the closed position and the open position.

20. The gas spring of claim 19, wherein the cross section of the longitudinal grooves decreases toward the closed position.

21. The gas spring of claim 20, wherein the piston rod or the projection of the piston is closed against the flow of gas in the area adjacent to the piston in the closed position.

22. The gas spring of claim 18, wherein the separating piston surrounds an area of the piston rod or a projection of the piston, and wherein the cross section of the area increases toward the closed position.

23. The gas spring of claim 19, wherein the piston rod or the projection of the piston is tightly surrounded by the separating piston in the closed position.

24. The gas spring of claim 12, wherein a second passage which connects the first working chamber to the first working space is located in the piston.

25. The gas spring according to claim 1, wherein a second connection, leading from the second working chamber to the first working chamber, is arranged in the piston, wherein a pretensioned nonreturn valve is arranged to block the flow in the second connection from the second working chamber to the first working chamber.

26. The gas spring according to claim 1, wherein the flow connection is formed in the piston, said gas spring having a valve with a closing element, a first spring urging the closing element in a direction toward an open position, and said closing element being movable into a closed position by the magnetic field in opposition to the urgency of the first spring.

27. The gas spring of claim 26, wherein the valve is a slide valve with a slide element which in movable transversely with respect to the longitudinal dimension of the gas spring in a slide guide defined in said piston, the slide element comprising a magnetic material.

28. The gas spring of claim 27, wherein the closing element is urged by a second spring in the longitudinal outward direction from a lateral surface of said slide element, for closing, in a closed position, the opening in the slide guide of the flow connection leading from the second working chamber to the first working chamber.

29. The gas spring of claim 26, wherein the valve is a seat valve including a valve element of which is movable into a closed position transversely with respect to the longitudinal direction of the gas spring, the valve further comprising a link slide movable by the magnetic field transversely with respect to the longitudinal direction of the gas spring in opposition to the first spring, the link slide having a link arranged for actuating the valve element and moving it from its open position into its closed position.

30. The gas spring of claim 29, wherein the link slide is urged in the longitudinal direction of the gas spring by the force of a second spring acting in the closing direction of the valve element.
